(19) United States
(12) Patent Application Publication
(10) Pub. No.: US 2003/0189036 A1
(43) Pub. Date: Oct. 9, 2003

(54) Silicon carbide electric heating element

(75) Inventors: Sung-Jin Han, Seoul (KR); Wan-Soo Kim, Gyeonggi-Do (KR)

Correspondence Address: FLESHNER & KIM, LLP, P.O. Box 221200, Chantilly, VA, 20153-1200, US

(73) Assignee: LG ELECTRONICS INC.

(21) Appl. No.: 10/372,784

(22) Filed: Feb. 26, 2003

(30) Foreign Application Priority Data
Apr. 9, 2002 (KR) 19261/2002

(51) Int. Cl. H05B 3/08; H05B 3/10

(52) U.S. Cl. 219/541; 219/553

(57) ABSTRACT

A silicon carbide electric heating element includes: a terminal part to which power is supplied; a heat generation part connected to the terminal part and generating heat; and a cooling part formed at the terminal part to cool the terminal part. Since the terminal part is not heated, the electric wire can be directly connected for use to the terminal part without an additional connection member.

### BACKGROUND OF THE INVENTION

1. Field of the Invention

The present invention relates to an electric heating element and, more particularly, to a silicon carbide electric heating element that is capable of preventing overheat of a terminal part by enhancing configuration of the terminal part.

2. Description of the Background Art

An electric heating element is a element in which when electricity is applied to a terminal part positioned at both ends thereof, a heat generation part positioned at the middle portion of the electric heating element generates heat.

Among electric heating elements, silicon carbide electric heating element is widely used, extending from a heater for home use to an industrial electric furnace thanks to its advantage that its surface temperature (1600˜1650° C.) is higher by 5-7 times than a metal heat generator such as nicrome wire.

FIG. 1 is a perspective view of a conventional silicon carbide electric heating element, and FIG. 2 is a vertical-sectional view of FIG. 1.

As shown in FIGS. 1 and 2, the conventional silicon carbide electric heating element 10 includes: a terminal part 11 positioned at both ends thereof, and a heat generation part 12 positioned between the terminal parts 11 and generating heat.

The terminal part 11 is a part to which power is supplied, and the heat generation part 12 generates a high temperature heat according to the supplied power.

Though the terminal part 11 does not generate a high temperature heat, it may be overheated due to heat transmitted from the heat generation part 12 or heat generated by itself. In such a case, a wire (W) connected to the silicon carbide electric heating element 10 can be damaged or disconnected.

In the conventional art, in order to protect the wire (W), a mesh type connection member 13 is inserted to the terminal part 11 and a clamp 14 is fixed at the mesh type connection member 13. A wire (W) is connected to a wire engaging hole 14 formed at the end of the mesh type connection member 13.

However, since the conventional silicon carbide electric heating element 10 must use the mesh type connection member 13 and the clamp 14 in order to connect the wire (W) to the terminal part 11, the installation and assembly operation are difficult and the fabrication cost is increased.

### SUMMARY OF THE INVENTION

Therefore, an object of the present invention is to provide a silicon carbide electric heating element that is capable of reducing a transmission amount of heat transmitted from a heat generation part to a terminal part and capable of quickly cooling the terminal part by increasing a discharge mount of heat of the terminal part.

To achieve these and other advantages and in accordance with the purpose of the present invention, as embodied and broadly described herein, there is provided a silicon carbide electric heating element including: a terminal part to which power is supplied, a heat generation part connected to the terminal part and generating heat; and a cooling part formed at the terminal part to cool the terminal part.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing a silicon carbide electric heating element in accordance with a conventional art;

FIG. 2 is a vertical-sectional view of FIG. 1;

FIG. 3 is a perspective view showing a silicon carbide electric heating element in accordance with a first embodiment of the present invention;

FIG. 4 is a cut perspective view showing a sectional area in longitudinal direction of a terminal part of FIG. 3;

FIG. 5 is a perspective view showing a silicon carbide electric heating element in accordance with a second embodiment of the present invention;

FIG. 6 is a perspective view showing a silicon carbide electric heating element in accordance with a third embodiment of the present invention;

FIG. 7 is a perspective view showing a silicon carbide electric heating element in accordance with a fourth embodiment of the present invention;

FIG. 8 is a perspective view showing a silicon carbide electric heating element in accordance with a fifth embodiment of the present invention;

FIG. 9 is a perspective view showing a silicon carbide electric heating element in accordance with a sixth embodiment of the present invention; and

FIG. 10 is a perspective view showing a silicon carbide electric heating element in accordance with a seventh embodiment of the present invention.

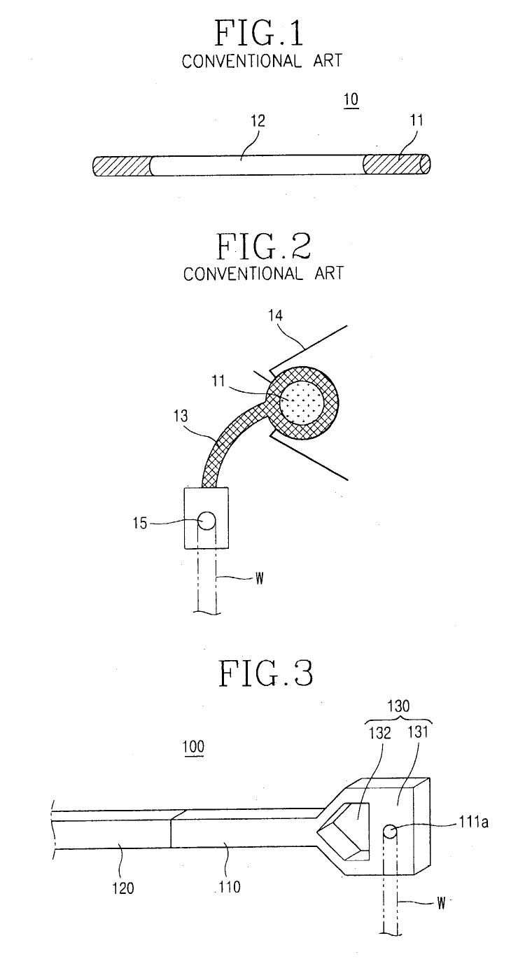

### DETAILED DESCRIPTION OF THE PREFERRED EMBODIMENTS

Reference will now be made in detail to the preferred embodiments of the present invention, examples of which are illustrated in the accompanying drawings.

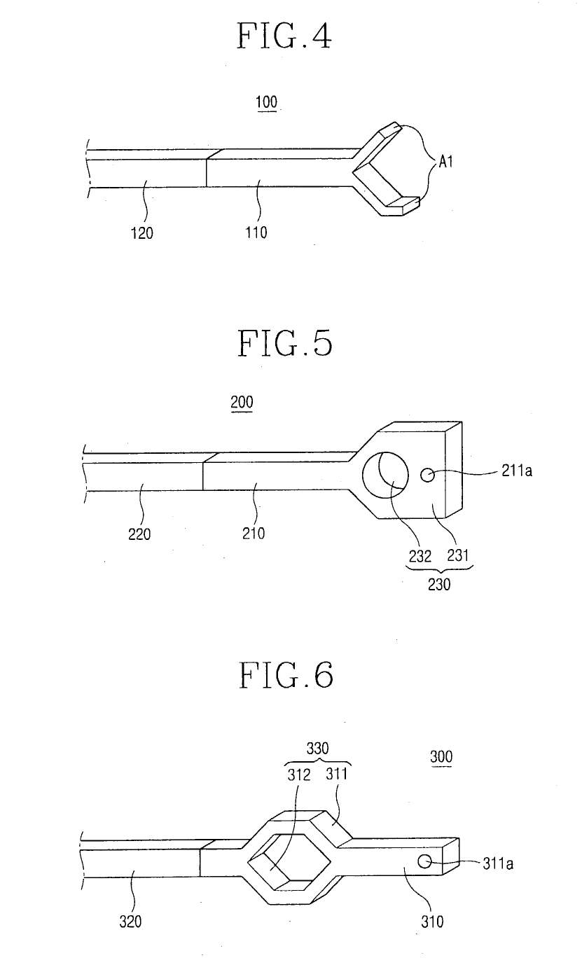

FIG. 3 is a perspective view showing a silicon carbide electric heating element in accordance with a first embodiment of the present invention, and FIG. 4 is a cut perspective view showing a sectional area in longitudinal direction of a terminal part of FIG. 3.

As illustrated, the silicon carbide electric heating element 100 in accordance with a first embodiment of the present invention includes a terminal part 110 to which power is supplied, a heat generation part 120 connected to the terminal part 110 and generating heat, and a cooling part 130 formed at the terminal part 110 to cool the terminal part 110.

In the first embodiment, the silicon carbide electric heating element is constructed such that heat is refrained from being transmitted to the terminal part 110 from the heat generation part 120 and transmitted heat can be quickly discharged in the air (in the atmosphere) so that the terminal part 110 may not be overheated during the operation of the electric heating element, and thus, the electric wire (W) can be directly connected to the wire engaging hole 111a of the terminal part 110.

In the first embodiment, in order to prevent overheating of the terminal part 110 of the silicon carbide electric heating element, a cooling part 130 is provided.

As one example of the cooling part 130, a surface area enlarging protrusion 111 is formed in a pentagon shape at the end portion of the terminal part 110 to increase the surface area of the terminal part.

That is, formation of the surface area enlarging protrusion 111 at the terminal part 110 leads to enlargement of the overall surface area of the terminal part 110 and increase in a discharging amount of heat, so that the terminal part can be quickly cooled.

As another example of the cooling part 130, a pentagonal cooling hole 132 is penetratingly formed at the surface area enlarging protrusion 111 to reduce the amount of transmission of heat transmitted from the terminal part 110. One or more pentagonal cooling hole 132 may be formed relying on the size of the surface area enlarging protrusion 131 or in consideration of cooling.

The operation and effect of the silicon carbide electric heating element constructed as described above will now be explained with reference to FIGS. 3 and 4.

When power is supplied to the terminal part 110 through the electric wire (W) coupled to the wire engaging hole 111a formed at the terminal part 110 of the silicon carbide electric heating element 100, the heat generation part 120 is heated to a high temperature.

The high temperature heat of the heat generation part 120 is transmitted to the terminal part 110, of which a heat transmission amount equation can be expressed as follows:

$$Heat transmission amount ( Q1 ) = coefficient of thermal conductivity ( K 1 ) * longitudinal surface area ( A1 ) * temperature difference ( T1 ) between heat generation part and terminal part \qquad equation \text{(1)}$$

As noted in equation (1), the heat transmission amount (Q1) is in proportion to the longitudinal surface area (A1).

In the first embodiment of the present invention, as the cooling hole 132 is penetratingly formed at the side of the surface area enlarging protrusion 111 of the terminal part 110, the longitudinal surface area (A1) is reduced as much.

And with the reduced longitudinal surface area (A1), the heat transmission amount (Q1) is reduced, and accordingly, the transmission amount (Q1) of heat transmitted from the heat generation part 120 to the terminal part 110 is reduced.

Reduction of the transmission amount (Q1) of heat transmitted from the heat generation part 120 to the terminal part 110 signifies that the high temperature heat of the heat generation part 120 is hardly transmitted to the terminal part 110, according to which the terminal part 110 is not overheated.

In the first embodiment of the present invention, with the formation of the surface area enlarging protrusion 111 at the terminal part 110, the surface area (A2) of the terminal part is increased, of which a discharge amount equation of heat discharged in the air is as follows:

$$Heat discharge amount ( Q2 ) = coefficient of heat convection ( K2 ) * surface area ( A2 ) of terminal part * temperature difference between terminal part and the atmosphere \qquad ( 2 )$$

As noted in equation (2), the heat transmission amount (Q2) is in proportion to the surface area (A2) of the terminal part.

The larger the surface area (A2) of the terminal part, the greater the heat transmission amount (Q2), so that the terminal part 110 is quickly cooled.

As aforementioned, in the first embodiment of the present invention, since the overheat of the terminal part 110 can be prevented by reducing the heat transmission amount (Q1) and increasing the heat discharge amount (Q2), the electric wire (WO can be directly connected to the terminal part 110.

FIG. 5 is a perspective view showing a silicon carbide electric heating element in accordance with a second embodiment of the present invention.

As shown in FIG. 5, a silicon carbide electric heating element 200 in accordance with a second embodiment of the present invention includes: a terminal part 210 to which power is supplied, a heat generation part 220 connected to the terminal part 210 and generating heat; and a cooling part 230 formed at the terminal part 210 to cool the terminal part 210.

The silicon carbide electric heating element of the second embodiment of the present invention also includes the cooling part 230 in order to prevent overheat of the terminal part 210.

As one example of the cooling part 230, a pentagonal surface area enlarging protrusion 231 is formed at an end portion of the terminal part 210 in order to increase the surface area of the terminal part 210.

That is, formation of the surface area enlarging protrusion 231 at the terminal part 210 leads to enlargement of the overall surface area of the terminal part 210 and increase in a discharging amount of heat, so that the terminal part can be quickly cooled.

In addition, in order to reduce the transmission amount of heat transmitted from the heat generation part 220 to the terminal part 210, a circular cooling hole 232 is penetratingly formed at the side of the surface area enlarging protrusion 231. One or more circular cooling holes 232 can be formed depending on the size of the surface area enlarging protrusion 231 or in consideration of cooling.. to In the second embodiment, the silicon carbide electric heating element is constructed such that heat is refrained from being transmitted to the terminal part 210 from the heat generation part 220 and the transmitted heat, if any, can be quickly discharged in the air (in the atmosphere) so that the terminal part 210 may not be overheated during the operation of the electric heating element, and thus, the electric wire (W) can be directly connected to the wire engaging hole 211a of the terminal part 210.

FIG. 6 is a perspective view showing a silicon carbide electric heating element in accordance with a third embodiment of the present invention.

As shown in FIG. 6, a silicon carbide electric heating element 300 in accordance with a third embodiment of the present invention includes: a terminal part 310 to which power is supplied, a heat generation part 320 connected to the terminal part 310 and generating heat; and a cooling part 330 formed at the terminal part 310 to cool the terminal part 310.

The silicon carbide electric heating element of the third embodiment of the 25 present invention also includes the cooling part 330 in order to prevent overheat of the terminal part 310.

As one example of the cooling part 330, a hexagonal surface area enlarging protrusion 311 is formed at the middle portion of the terminal part 310 in order to increase the surface area of the terminal part 310.

That is, formation of the surface area enlarging protrusion 311 at the terminal part 310 leads to enlargement of the overall surface area of the terminal part 310 and increase in a discharging amount of heat, so that the terminal part 310 can be quickly cooled.

In addition, in order to reduce the transmission amount of heat transmitted from the heat generation part 320 to the terminal part 310, a hexagonal cooling hole 312 is penetratingly formed at the side of the surface area enlarging protrusion 311. One or more hexagonal cooling holes 312 can be formed depending on the size of the surface area enlarging protrusion 311 or in consideration of cooling.

In the third embodiment, the silicon carbide electric heating element is constructed such that heat is refrained from being transmitted to the terminal part 310 from the heat generation part 320 and the transmitted heat, if any, can be quickly discharged in the air (in the atmosphere) so that the terminal part 310 may not be overheated during the operation of the electric heating element, and thus, the electric wire (W) can be directly connected to the wire engaging hole 311a of the terminal part 310.

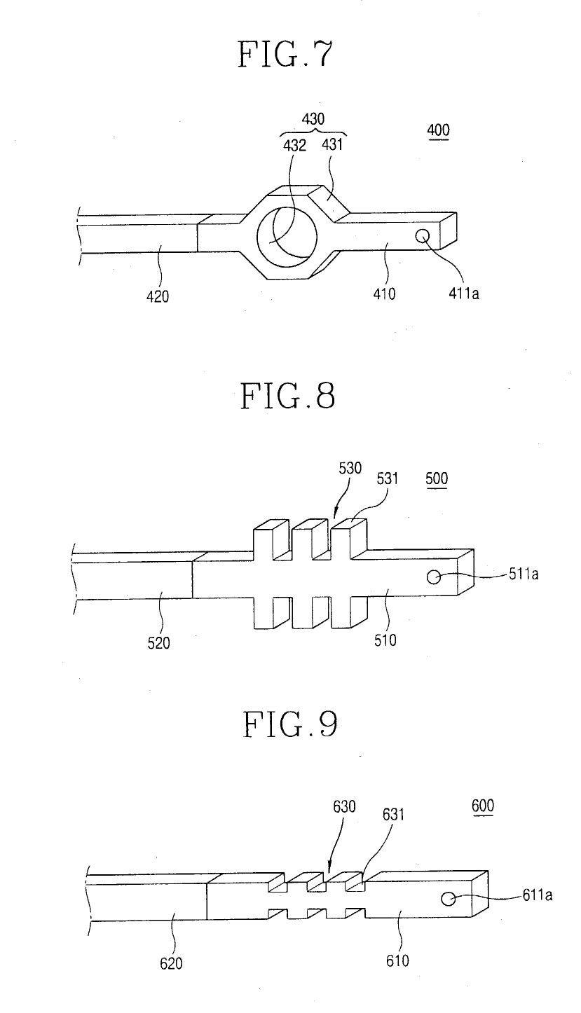

FIG. 7 is a perspective view showing a silicon carbide electric heating element in accordance with a fourth embodiment of the present invention.

As shown in FIG. 7, a silicon carbide electric heating element 400 in accordance with a fourth embodiment of the present invention includes: a terminal part 410 to which power is supplied, a heat generation part 420 connected to the terminal part 410 and generating heat; and a cooling part 430 formed at the terminal part 410 to cool the terminal part 410.

The silicon carbide electric heating element of the fourth embodiment of the present invention also includes the cooling part 430 in order to prevent overheat of the terminal part 410.

As one example of the cooling part 430, a pentagonal surface area enlarging protrusion 431 is formed at the middle portion of the terminal part 410 in order to increase the surface area of the terminal part 410. to That is, formation of the surface area enlarging protrusion 431 at the terminal part 410 leads to enlargement of the overall surface area of the terminal part 410 and increase in a discharging amount of heat, so that the terminal part 410 can be quickly cooled.

In addition, in order to reduce the transmission amount of heat transmitted from the heat generation part 420 to the terminal part 410, a circular cooling hole 412 is penetratingly formed at the side of the surface area enlarging protrusion 431. One or more hexagonal cooling holes 412 can be formed depending on the size of the surface area enlarging protrusion 431 or in consideration of cooling.

In the fourth embodiment, the silicon carbide electric heating element is constructed such that heat is refrained from being transmitted to the terminal part 410 from the heat generation part 420 and the transmitted heat, if any, can be quickly discharged in the air (in the atmosphere) so that the terminal part 410 may not be overheated during the operation of the electric heating element, and thus, the electric wire (W) can be directly connected to the wire engaging hole 411a of the terminal part 410.

FIG. 8 is a perspective view showing a silicon carbide electric heating element in accordance with a fifth embodiment of the present invention.

As shown in FIG. 8, a silicon carbide electric heating element 500 in accordance with a fifth embodiment of the present invention includes: a terminal part 510 to which power is supplied, a heat generation part 520 connected to the terminal part 510 and generating heat; and a cooling part 530 formed at the terminal part 510 to cool the terminal part 510.

The silicon carbide electric heating element of the fifth embodiment of the present invention also includes the cooling part 530 in order to prevent overheat of the terminal part 510.

As one example of the cooling part 530, a plurality of cooling protrusion 531 are formed at equal intervals at the middle portion of surface of the terminal part 510 in order to increase the overall surface area of the terminal part 510.

That is, formation of the protrusions at the surface of the terminal part 510 leads to enlargement of the surface area of the terminal part 510, so that the terminal part 510 can be quickly cooled.

In the fifth embodiment, the silicon carbide electric heating element is constructed such that heat transmitted from the heat generation part 520 to the terminal part 510 can be quickly discharged in the air (in the atmosphere) so that the terminal part 510 may not be overheated during the operation of the electric heating element, and thus, the electric wire (W) can be directly connected to the wire engaging hole 511a of the terminal part 510.

FIG. 9 is a perspective view showing a silicon carbide electric heating element in accordance with a sixth embodiment of the present invention.

As shown in FIG. 9, a silicon carbide electric heating element 600 in accordance with a sixth embodiment of the present invention includes: a terminal part 610 to which power is supplied, a heat generation part 620 connected to the terminal part 610 and generating heat; and a cooling part 630 formed at the terminal part 610 to cool the terminal part 610.

The silicon carbide electric heating element of the sixth embodiment of the present invention also includes the cooling part 630 in order to prevent overheat of the terminal part 610.

As one example of the cooling part 630, a plurality of cooling recesses 631 are formed at equal intervals at both sides of the terminal part 610 in order to reduce the transmission amount of heat transmitted from the heat generation part 620 to the terminal part 610.

That is, formation of the cooling recesses 631 at both sides of the terminal part 610 leads to enlargement of the surface area of the terminal part 610, so that the terminal part 610 can be quickly cooled.

In the sixth embodiment, the silicon carbide electric heating element is constructed such that heat transmitted from the heat generation part 620 to the terminal part 610 can be quickly discharged in the air (in the atmosphere) so that the terminal part 610 may not be overheated during the operation of the electric heating element, and thus, the electric wire (W) can .be directly connected to the wire engaging hole 611a of the terminal part 610.

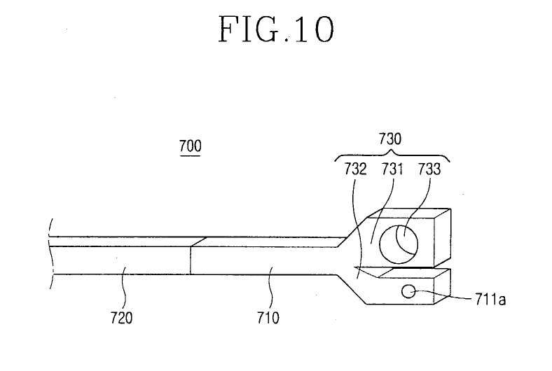

FIG. 10 is a perspective view showing a silicon carbide electric heating element in accordance with a seventh embodiment of the present invention.

As shown in FIG. 10, a silicon carbide electric heating element 700 in accordance with a seventh embodiment of the present invention includes: a terminal part 710 to which power is supplied, a heat generation part 720 connected to the terminal part 710 and generating heat; and a cooling part 730 formed at the terminal part 710 to cool the terminal part 710.

The silicon carbide electric heating element of the seventh embodiment of the present invention also includes the cooling part 730 in order to prevent overheat of the terminal part 710.

The cooling part 730 consists of a cooling branch 731 and a wire engaging branch 732. The cooling branch and the wire engaging branch 732 are formed by cutting an end portion of the terminal part 710 in a horizontal direction.

The cooling branch 731 includes a cooling hole 733, and the wire engaging branch 732 includes a wire engaging hole 711a.

Dividing the end portion of the terminal part 710 into the cooling branch 731 and the wire engaging branch 732 leads to a rapid cooling of the cooling branch 731 by virtue of the cooling hole 733. Meanwhile, in case of the wire engaging branch 732, since its sectional area in the longitudinal direction is small compared to that of the cooling branch 731, heat is less transmitted thereto from the heat generation part 720. Accordingly, a damage to the electric wire can be effectively prevented.

As so far described, the silicon carbide electric heating element of the present invention has the following advantage.

That is, the sectional area of the terminal part is reduced to refrain heat transmission from the silicon carbide heat generation part to the terminal part or the overall surface area of the terminal part is increased to quickly cool the terminal part. Therefore, since the terminal part is not heated, the electric wire can be directly connected for use to the terminal part without an additional connection member.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A silicon carbide electric heating element comprising:
a terminal part to which power is supplied;
a heat generation part connected to the terminal part and generating heat; and
a cooling part formed at the terminal part to cool the terminal part.

2. The heating element of claim 1, wherein the cooling part is a surface area enlarging protrusion formed at the terminal part in order to increase the surface area.

3. The heating element of claim 2, wherein the surface area enlarging protrusion is formed at an end portion of the terminal part.

4. The heating element of claim 2, wherein the surface area enlarging protrusion is formed at the middle portion of the terminal part.

5. The heating element of claim 2, wherein the surface area enlarging protrusion is polygonal.

6. The heating element of claim 2, wherein a cooling hole is penetratingly formed at the side of the surface area enlarging protrusion in order to reduce a transmission amount of heat transmitted from the heat generation part to the terminal part.

7. The heating element of claim 6, wherein at least one or more cooling holes are formed.

8. The heating element of claim 1, wherein the cooling part is a cooling protrusion formed at the surface of the terminal part.

9. The heating element of claim 8, wherein a plurality of cooling protrusion are formed.

10. The heating element of claim 9, wherein the cooling protrusions are formed at equal intervals.

11. The heating element of claim 1, wherein the cooling part is a cooling recess formed at both sides of the terminal part 610 in order to reduce a transmission amount of heat transmitted from the heat generation part to the terminal part.

12. The heating element of claim 11, wherein a plurality of cooling recesses are formed at equal intervals.

13. The heating element of claim 1, wherein the cooling part comprises a cooling branch formed and a wire engaging branch which are dividedly formed by cutting an end portion of the terminal part.
